(19) United States
(12) Patent Application Publication
(10) Pub. No.: US 2009/0224149 A1
(43) Pub. Date: Sep. 10, 2009

(54) Raster scan system, raster scan method and program

(75) Inventor: Wataru Hattori, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Corporation, Tokyo (JP)

(21) Appl. No.: 12/379,986

(22) Filed: Mar. 5, 2009

(30) Foreign Application Priority Data
Mar. 6, 2008 (JP) 2008-057064

(51) Int. Cl. B01D 59/44; H01J 49/00

(52) U.S. Cl. 250/282; 250/492.1; 250/281

(57) ABSTRACT

An object of the present invention is to provide a technique through which a raster scan program which can obtain a signal which is more excellent in strength and sensitivity than a signal which is areally averaged within a well formed in a channel in an electrophoresis chip can be programmed. A raster scan system of the present invention is a raster scan system which raster-scans a sample accommodation portion of a chip through a laser, at least a matrix is in the sample accommodation portion, and an irradiation frequency for each laser irradiation location of the sample accommodation portion of the chip is determined based on an irradiation frequency dependence of a signal strength for each irradiation location of the sample accommodation portion which is obtained by irradiating a laser to the sample accommodation portion.

This application is based upon and claims the benefit of priority from Japanese patent application No. 2008-057064, filed on Mar. 6, 2008, the disclosure of which is incorporated herein in its entirety by reference.

### BACKGROUND OF THE INVENTION

1. Field of the Invention

The present invention relates to a raster scan technique which separates and dries a sample which is a target of mass analysis by electrophoresis in a channel of an electrophoresis chip, adds a matrix solution, and irradiates a laser by a matrix-assisted laser desorption/ionization mass spectrometry (MALDI-MS) apparatus to perform mass analysis.

2. Description of the Related Art

Recently, raster scan systems have been actively developed as disclosed in Japanese Patent Application National Publication (Laid-Open) No. 2005-517954 (patent document 1), K. Tseng et al., SPIE vol. 3606 (1999), pp. 137-148 (non patent document 1), J. Liu et al., Analytical Chemistry vol. 73, No. 9 (2001), pp. 2147-2151 (patent document 2), and M. Mok et al., Analyst vol. 129 (2004), pp. 109-110 (patent document 3). In raster systems, a solute such as protein contained in a sample solution is separated within a channel by capillary electrophoresis by using a groove-like channel which has a structure with an opened upper portion, that is, includes no lid, which is formed on a surface of a micro fluid chip (electrophoresis chip), or a removable lid for sealing an upper surface of a channel. The solute separated within a channel is dried while keeping a separation state. Then, an upper surface of a channel is opened, and a solution in which ionization catalyst called a matrix is dissolved is added to the dried solute, so that a matrix crystal of a state mixed with a sample is formed. A channel of a chip is irradiated by a laser using a MALDI-MS apparatus, so that a solute is ionized. Mass analysis is performed through such processes. A predetermined length of a channel length direction is regarded as one well, and a raster scan is performed for each well, so that a mass spectrum is obtained in units of wells.

On a typical target plate, a matrix randomly and non-uniformly produces a crystal, but a raster scan program which is embedded in a mass analysis apparatus in advance is programmed to uniformly irradiate a laser according to a shape of a well to obtain a mass spectrum. For example, if a well 1 has a circular shape as shown in FIG. 1, raster scan locations 3 are programmed so that one-time laser irradiation ranges 2 can be disposed within a circle. Also, if a well 1 has a rectangular shape as shown in FIG. 2, raster scan locations 3 are programmed so that one-time laser irradiation ranges 2 can be disposed within a rectangle. Therefore, a raster scan program can be executed without considering a production location of a matrix crystal including a lot of samples.

However, in case of the chip, a matrix solution is applied with good reproducibility in a well-controlled state. For example, a matrix solution is added, using a method such as a dispenser, a sprayer or an injector, while generating a matrix crystal which is well-mixed with a sample so that a separation pattern of a sample is not disordered in a channel and a matrix quantity is not varied in a channel length direction. In this case, a production method of a matrix crystal has a certain tendency according to an adding method. For example, a lot of matrix crystals can be produced at both ends of a channel width direction. In this case, if a raster scan in which a laser is uniformly irradiated is performed, both a place where many matrix crystals are produced in a channel width direction and a place where a few matrix crystals are produced have an equal mass spectrum, and thus there is a problem in that only signals which are areally averaged within a well are obtained.

In Japanese Patent Application Laid-Open (JP-A) No. 2007-257851 (patent document 2), when measurement is performed by a MALDI-MS technique using a target plate through which a location of a measurement target substance cannot be determined, the following steps [1] and [2] are performed to realize efficient measurement.

[1] The entire plate area is mostly scanned at a large step width to find out an approximate location of a measurement target substance (the entire plate area is approximately scanned).

[2] The approximate location of a measurement target substance found out in the step [1] is entirely scanned at a small step width.

The present invention has the following differences with patent document 2.

<1> Firstly, there is a difference in data used to determine the irradiation frequency. In the present invention, the irradiation frequency is determined by the irradiation frequency dependence of the signal strength. On the contrary, in patent document 2, a signal of a measurement target substance (sample in the present invention) is used to determine an irradiation location.

<2> In the present invention, the irradiation frequency is determined, whereas in patent document 2, an irradiation location is determined.

### SUMMARY

The present invention is devised to resolve the above-identified, and other problems associated with conventional methods and apparatuses, and an object of the present invention is to provide a raster scan system, a raster scan method and a program through which a raster scan program which can obtain a signal which is more excellent in strength and sensitivity than a signal which is areally averaged within a well formed in a channel in an electrophoresis chip can be programmed.

In order to achieve the object, the present invention has the following features.

### <Raster Scan System>

In an aspect of the present invention, there is provided a raster scan system which raster-scans a sample accommodation portion of a chip through a laser, including: a unit which determines an irradiation frequency for each laser irradiation location of the sample accommodation portion of the chip based on an irradiation frequency dependence of a signal strength for each irradiation location of the sample accommodation portion which is obtained by irradiating a laser to the sample accommodation portion, wherein at least a matrix is in the sample accommodation portion.

In another aspect of the present invention, there is provided a raster scan system which raster-scans a sample accommodation portion of a chip through a laser, including: a unit which irradiates a laser to the sample accommodation portion in advance; and a unit which determines an irradiation frequency for each laser irradiation location of the sample accommodation portion of the chip based on an irradiation frequency dependence of a signal strength for each irradiation location of the sample accommodation portion which is obtained by irradiating a laser to the sample accommodation portion, wherein at least a matrix is in the sample accommodation portion.

### <Raster Scan Method>

In an aspect of the present invention, there is provided a raster scan method which raster-scans a sample accommodation portion of a chip through a laser, including: determining an irradiation frequency for each laser irradiation location of the sample accommodation portion of the chip based on an irradiation frequency dependence of a signal strength for each irradiation location of the sample accommodation portion which is obtained by irradiating a laser to the sample accommodation portion, wherein at least a matrix is in the sample accommodation portion.

In another aspect of the present invention, there is provided a raster scan method which raster-scans a sample accommodation portion of a chip through a laser, including: a first step of irradiating a laser to the sample accommodation portion in advance, and a second step of determining an irradiation frequency for each laser irradiation location of the sample accommodation portion of the chip based on an irradiation frequency dependence of a signal strength for each irradiation location of the sample accommodation portion which is obtained by irradiating a laser to the sample accommodation portion, wherein at least a matrix is in the sample accommodation portion.

### <Program>

In an aspect of the present invention, there is provided a program which raster-scans a sample accommodation portion of a chip through a laser, for allowing a computer to execute: a process of determining an irradiation frequency for each laser irradiation location of the sample accommodation portion of the chip based on an irradiation frequency dependence of a signal strength for each irradiation location of the sample accommodation portion which is obtained by irradiating a laser to the sample accommodation portion including at least matrix.

In another aspect of the present invention, there is provided a program which raster-scans a sample accommodation portion of a chip through a laser, for allowing a computer to execute: a first process of irradiating a laser to the sample accommodation portion including at least a matrix in advance, and a second process of determining an irradiation frequency for each laser irradiation location of the sample accommodation portion of the chip based on an irradiation frequency dependence of a signal strength for each irradiation location of the sample accommodation portion which is obtained by irradiating a laser to the sample accommodation portion.

### BRIEF DESCRIPTION OF THE DRAWINGS

FIG. 1 is a view illustrating a raster scan program typically used when a well has a circular shape;

FIG. 2 is a view illustrating a raster scan program typically used when a well has a rectangular shape;

FIG. 3 is a view illustrating a relationship between a location of an irradiation laser which is measured while scanning at an interval of equal to or less than an irradiation laser diameter in a channel width direction and a well in order to determine a tendency of a production method of a matrix crystal of a channel width direction;

FIG. 4 is a graph illustrating a measurement result for determining a tendency of a production method of a matrix crystal of a channel width direction;

FIG. 5 is a graph illustrating an improvement result by a raster scan system according to an exemplary embodiment of the present invention;

FIG. 6A is a block diagram illustrating a raster scan system according to the exemplary embodiment of the present invention; and

FIG. 6B is a flowchart illustrating an operation of a raster scan system according to the exemplary embodiment of the present invention (raster scan method according to the exemplary embodiment of the present invention).

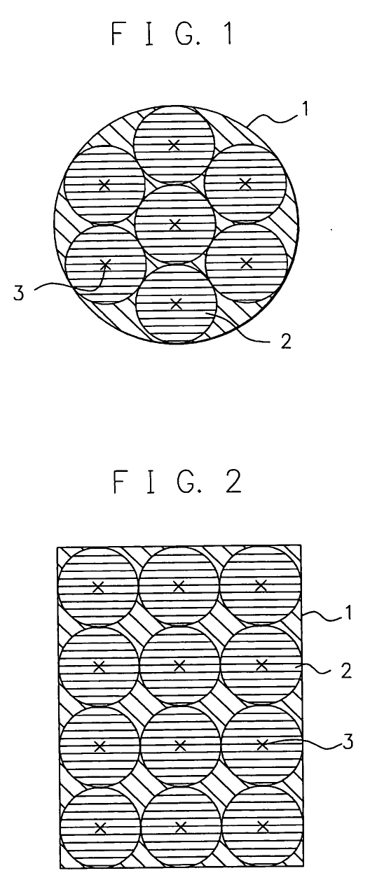

### EXEMPLARY EMBODIMENT

Hereinafter, exemplary embodiments of the present invention will be described in detail.

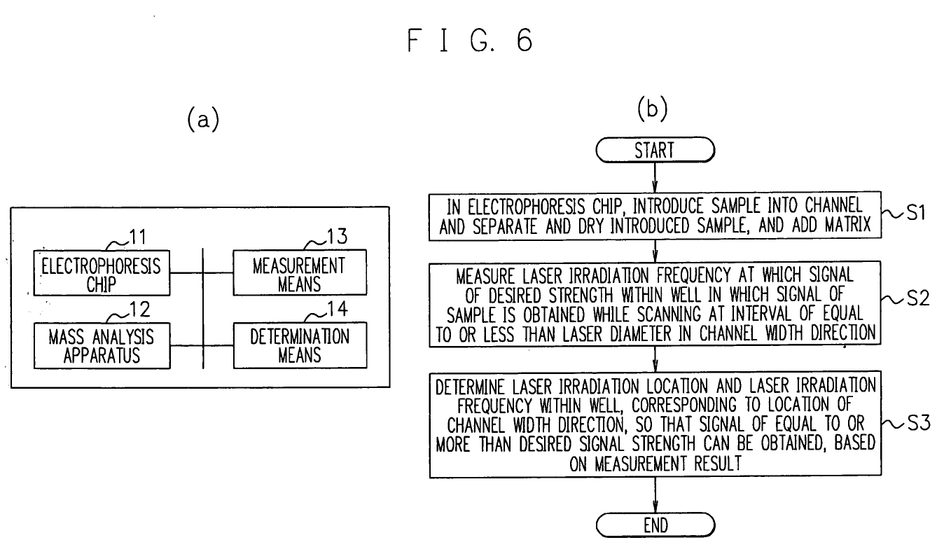

A raster scan system according to an exemplary embodiment of the present invention includes an electrophoresis chip 11 and a mass analysis apparatus (MALDI-MS apparatus) 12 which are a typical configuration and further includes measurement means (laser irradiation measurement apparatus) 13 and determination means (laser irradiation determination apparatus) 14 which are a novel configuration of the present embodiment as shown in FIG. 6A. The measurement means and the determination means perform a measurement step and a determination step which will be described later, respectively. In the present embodiment, the measurement means and the determination means are configured as discrete elements but can be configured as one means which has both functions.

The electrophoresis chip 11 includes a channel (sample accommodation portion) in which a sample which is a target of mass analysis is subjected to electrophoresis.

A sample introduced into the electrophoresis chip 11 is locationally separated and dried by electrophoresis within a channel, and a matrix is added. Then, a laser is irradiated for each well defined along a channel location by the mass analysis apparatus 12, so that a mass spectrum is detected.

In the raster scan system, a matrix solution is applied with good reproducibility in a well-controlled state and is added while generating a matrix crystal which is well-mixed with a sample so that a separation pattern of a sample within a channel is not disordered and a matrix quantity is not varied in a channel length direction. In this case, a production method of a matrix crystal of a channel width direction has a certain tendency.

In order to determine a tendency of a production method of a matrix crystal of a channel width direction, in the raster scan system, a standard sample is introduced into a channel, separated, and dried, a matrix is added, and then a measurement step is performed by the measuring means 13. The measurement step is a step of measuring the laser irradiation frequency at which a signal of a desired strength is obtained within a well in which a signal of a sample is obtained while scanning at an interval of equal to or less than an irradiation laser diameter in a channel width direction when irradiating a laser through the mass analysis apparatus 12 after adding a matrix. Through the above step, irradiation frequency dependence of the signal strength for each irradiation location of the sampling accommodation portion can be determined. Here, “irradiation frequency dependence of the signal strength for each irradiation location of the sampling accommodation portion” represents a property in which the signal strength of each irradiation location of the laser in sample accommodation portion detected through the mass analysis apparatus varies depending on the laser irradiation frequency. In the present embodiment, the laser irradiation frequency at which a signal of a desired strength is obtained within a well in which a signal of a sample is obtained is measured for each of lines L1 to L9, which will be described later. As the measurement result, for example, a graph shown in FIG. 4 is obtained. In FIG. 4, a horizontal axis denotes the laser irradiation frequency per point, and a vertical axis denotes the signal strength per line. In this case, a laser irradiation location corresponds to each line, and information of the signal strength which varies depending on the laser irradiation frequency is obtained for each line.

After the measurement step, the raster scan system performs a determination step through the determination means 14. The determination step is a step of determining a laser irradiation location and the laser irradiation frequency within a well based on the measurement result of the measurement step so that a laser can be irradiated, corresponding to a location of a channel width direction, as many times as the number of times that a signal having a strength equal to or more than a desired signal strength is obtained.

Based on the measurement step and the determination step, the laser irradiation frequency is increased for a location where more signals are obtained, and the laser irradiation frequency is reduced or a laser is not irradiated for a location where a signal is not obtained. Therefore, a laser is uniformly irradiated within a well, so that more signals are obtained at an irradiation location at which a signal stronger than a signal which is areally averaged within a well is obtained, and fewer signals are obtained at an irradiation location at which weaker signals are obtained. Therefore, the raster scan system can finally obtain a signal which is more excellent in strength or sensitivity than a signal which is areally averaged within a well.

An operation of the raster scan system according to the present embodiment (an exemplary embodiment of a raster scan method according to the present invention) will be described with reference to the drawings. In the drawings, like reference numerals denote like parts, and thus a duplicated description will not be repeated.

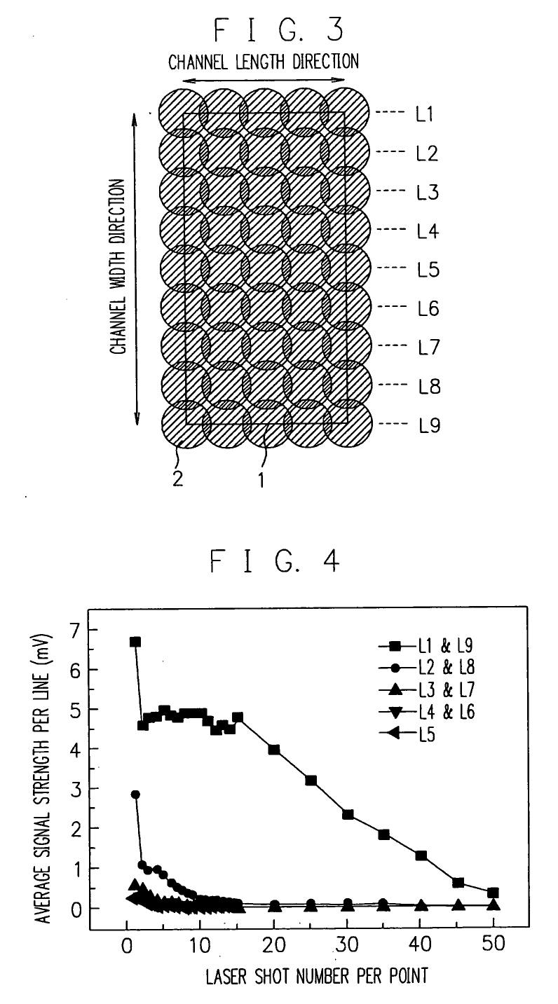

FIG. 3 illustrates a relationship between a location of an irradiation laser which is measured while scanning at an interval of equal to or less than an irradiation laser diameter in a channel width direction and a well in order to determine a tendency of a production method of a matrix crystal of a channel width direction. A well 1 configures part of a channel and typically has a rectangular shape if a channel is a straight line type channel. For example, a channel width direction and a channel length direction can be set to 1 mm and 0.5 mm, respectively. In order to detect a sample which exists within the well 1, for example, one-time laser irradiation ranges 2 are aligned at an interval of equal to or less than an irradiation laser diameter to compactly cover the well 1 as shown in FIG. 3. Here, the laser irradiation ranges 2 aligned in a channel length direction are denoted from the top of the well as L1 to L9.

The raster scan system of the present embodiment introduces a standard sample into a channel, separates and dries the standard sample and adds a matrix to the sample in the channel as an introduction step (step S1 of FIG. 6B).

Next, the raster scan system of the present embodiment measures the laser irradiation frequency at which a signal of a desired strength is obtained within the well in which a signal of the sample is obtained while scanning at an interval of equal to or less than an irradiation laser diameter in a channel width direction when irradiating a laser after adding a matrix, as a measurement step (step S2 of FIG. 6B).

For example, the raster scan system of the present embodiment measures the laser irradiation frequency, at which a signal of a desired strength is obtained within a well in which a signal of the sample is obtained, for each line of L1 to L9. Preferably, the standard sample is matched in density and molecular weight in the measured well with a target sample if possible. This is because if density varies, the frequency at which a strong signal is obtained varies. Also, even when a molecular weight varies, ionization efficiency greatly varies.

As the measurement result, for example, a graph of FIG. 4 is obtained. In FIG. 4, a horizontal axis denotes the laser irradiation frequency per point, and a vertical axis denotes the signal strength per line. In this case, since the well has a rectangular shape and a vertically symmetrical shape, measurement is performed by a combination of lines L1 and L9, lines L2 and L8, lines L3 and L7, lines L4 and L6, and a line L5. In the measurement step, if a tendency of a production method of a matrix crystal of a channel width direction is determined, a method can be appropriately changed.

Next, the raster scan system of the present embodiment determines a laser irradiation location and the laser irradiation frequency within the well so that a signal having strength equal to or more than a desired signal strength can be obtained corresponding to a location of a channel width direction based on the measurement result as the determination step (step S3 of FIG. 6B).

A concrete example of the determination step is described below. For example, in case where the graph of FIG. 4 is obtained as the measurement result, a raster scan program in which laser irradiation is performed 30 times for lines L1 and L9, and laser irradiation is performed once for lines L2 and L8 is obtained when considering a laser irradiation location and the laser irradiation frequency in which a signal of equal to or more than 2 mV is obtained. Here, the laser irradiation frequency can be set to a unit of, for example, five times by a restriction of a mass analysis apparatus. In this case, the raster scan system of the present embodiment appropriately programs a raster scan program within the restriction range. For example, based on the graph of FIG. 4, a raster scan program 1 can be programmed to irradiate 30 times per point for lines L1 and L9 and 5 times per point for lines L2 and L8, and a raster scan program 2 can be programmed to irradiate 45 times per point for lines L1 and L9, 10 times per point for lines L2 and L8 and five times per point for lines L3 and L7. In this case, the raster scan program 1 has the laser irradiation frequency of 350 times, and the raster scan program 2 has the laser irradiation frequency of 600 times.

Meanwhile, if a function of a standard apparatus for programming a raster scan program is used in the mass analysis apparatus, a program (referred to as “average method”) in which each laser irradiation range 2 of FIG. 3 is irradiated 10 times by a laser and thus laser irradiation of total 450 times per well is performed is programmed. A program in which a laser is areally averagely irradiated within a well similar to it is programmed.

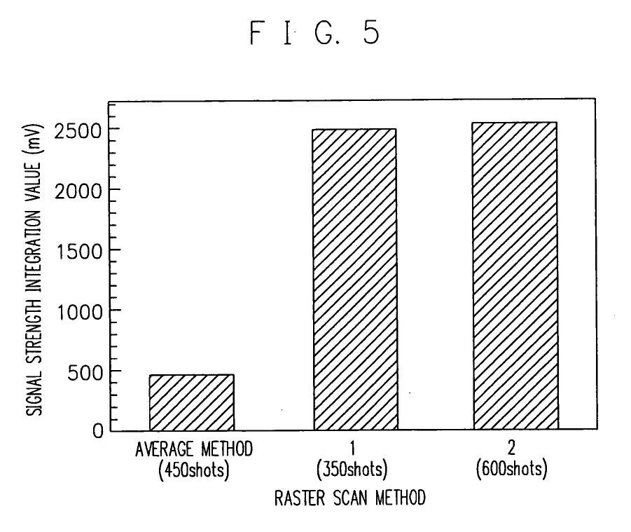

A result in which the signal strength is actually measured in the raster scan program is shown in FIG. 5. As shown in FIG. 5, the raster scan 1 and 2 of the raster scan system of the present embodiment obtain a signal strength which is about five times as strong as the average method. Also, in the raster scan program 1 which is few in laser irradiation frequency, a signal which is seven times stronger per one-time laser irradiation is obtained. That is, sensitivity is seven times improved.

As described above, according to the present embodiment, a signal which is more excellent in strength or sensitivity than a signal which is areally averaged within a well formed in a channel of an electrophoresis chip can be obtained. A raster scan program in which the above result can be obtained can be programmed.

As effects of the present embodiment, the signal strength and sensitivity of the MALDI-MS are improved, and if narrowing-down of an analysis location is performed once, a sample contained in the same chip can be immediately measured for the second or later time (no narrowing down again). The reasons are as follows:

[1] A technique for almost uniformly adding a matrix within a channel of a chip is used,

[2] A dummy chip is prepared, a laser irradiation location and the laser irradiation frequency in which the signal strength of equal to or more than a certain strength within a well can be obtained are measured, and a raster scan is set by their combination, and

[3] As a setting method of a raster scan according to the present embodiment, the signal strength is integrated per well and compared, but it is different from a technique disclosed in patent document 2 in which the signal strength is detected per laser irradiation and compared. Also, the well has a large area enough to set a raster scan, that is, about 10 times as large as a laser irradiation area.

In the present embodiment, as a characteristic operation, a scan which changes a laser irradiation location a little which takes a time in patent document 2 is performed, and the laser irradiation frequency at which a signal strength of equal to or more than a certain strength can be obtained is measured for each location. Therefore, for example, measurement in which a raster scan which is currently used is set takes a time of 30 or more times. Due to these differences, the present embodiment has the following effects.

<<1>> Sensitivity is improved since signals can be integrated while increasing the laser irradiation frequency as long as a signal of a desired signal strength can be obtained at each laser irradiation location within a well.

<<2>> The signal strength can be compared for each well since the same raster scan is used for each well.

Differences with patent document 2 are additionally described below. Since in a spatial resolution and a microprobe mass analysis apparatus of patent document 2, a microprobe mass analysis apparatus spatially resolves a signal of a desired molecular weight to obtain a two-dimensional image, and thus there is a need for obtaining a signal of a desired molecular weight for each laser irradiation location on a sample surface while increasing or decreasing a laser irradiation diameter.

However, in the present embodiment, since the signal strength is finally compared for each well regardless of how to perform a raster scan within a well, the signal strength of each laser irradiation location is not reflected in a final measurement result. Therefore, the raster scan method of the present embodiment cannot be applied to the microprobe mass analysis apparatus disclosed in patent document 2, and thus there is no reason for using the method of patent document 2 in detecting a chip according to the present embodiment. For example, in patent document 2, a MALDI-MS is used as an imaging device, and in the present invention, a MALDI-MS is used as a simple detector (for example, illuminometer) for each well. Since one sample is used for one well in a typical MALDI-MS, in case of patent document 2, a surface distribution of a material of a desired molecular weight within the sample is measured, but in the present embodiment, a mass spectrum for the entire sample is measured.

The raster scan method (raster scan program) determined according to the present embodiment can be used in other samples (chips) or wells. Actually, a raster scan method is determined by a dummy chip or a chip for a condition suggestion in advance, and then a sample is measured using the determined raster scan method (raster scan program). Since the same raster scan method is used, measurement results of chips can be compared without measurement deviation between chips.

In the present embodiment, it is preferred to scan a laser at an interval of “equal to or less than an irradiation laser diameter” within a well, but the present embodiment is not limited to this and can be applied even when scanning at an interval of “more than an irradiation laser diameter”.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

For example, the operation of the present embodiment described above can be realized by hardware, software or a combination configuration thereof.

When processing is performed by software, a program which records a processing sequence can be installed and executed in a memory in a computer embedded in dedicated hardware. The program can be installed and executed in a universal computer in which various processing can be performed.

For example, the program can be recorded on a recording medium such as a hard disk or a read only memory (ROM) in advance. The program can be also temporarily or permanently stored (recorded) on a removable recording medium such as compact disc read only memories (CD-ROMs), magneto optical (MO) discs, digital versatile discs (DVDs), magnetic discs, and semiconductor memories. The removable recording medium can be provided as so-called package software.

Besides the method for installing the program in a computer from the removable recording medium, the program can be wirelessly transferred to a computer from a download site or transferred with wire through a network such as a local area network (LAN) or the Internet. The computer can receive the transferred program and install the program in a recording medium such as a built-in hard disk.

The processing operation of the embodiment described above can be performed not only in time-series but also in parallel or independently according to a processing ability of an apparatus for performing the processing or a need.

The system described in the embodiment described above can be configured in such a way that a plurality of apparatuses is logically assembled or functions of respective apparatuses are mixed.

What is claimed is:

1. A raster scan system which raster-scans a sample accommodation portion of a chip through a laser, comprising:
a unit which determines an irradiation frequency for each laser irradiation location of the sample accommodation portion of the chip based on an irradiation frequency dependence of a signal strength for each irradiation location of the sample accommodation portion which is obtained by irradiating a laser to the sample accommodation portion,
wherein at least a matrix is in the sample accommodation portion.

2. A raster scan system which raster-scans a sample accommodation portion of a chip through a laser, comprising:
a unit which irradiates a laser to the sample accommodation portion in advance; and
a unit which determines an irradiation frequency for each laser irradiation location of the sample accommodation portion of the chip based on an irradiation frequency dependence of a signal strength for each irradiation location of the sample accommodation portion which is obtained by irradiating a laser to the sample accommodation portion,
wherein at least a matrix is in the sample accommodation portion.

3. The raster scan system of claim 1,
wherein the irradiation frequency is determined based on an irradiation frequency at which a signal of a strength equal to or more than a desired signal strength at the irradiation location is obtained.

4. The raster scan system of claim 1,
wherein the sample accommodation portion has a channel shape, and the raster scan is performed in a division unit obtained by dividing the sample accommodation portion in a width direction.

5. The raster scan system of claim 1,
wherein a sample is in the sample accommodation portion.

6. The raster scan system of claim 5,
wherein the sample is separated by electrophoresis.

7. The raster scan system of claim 1,
wherein the raster scan is performed at an interval of equal to or less than a laser diameter.

8. The raster scan system of claim 2, wherein a laser is irradiated to an irradiation location of the sample accommodation portion of the chip as many times as the determined irradiation frequency.

9. A raster scan method which raster-scans a sample accommodation portion of a chip through a laser, comprising:
determining an irradiation frequency for each laser irradiation location of the sample accommodation portion of the chip based on an irradiation frequency dependence of a signal strength for each irradiation location of the sample accommodation portion which is obtained by irradiating a laser to the sample accommodation portion,
wherein at least a matrix is in the sample accommodation portion.

10. A raster scan method which raster-scans a sample accommodation portion of a chip through a laser, comprising:
a first step of irradiating a laser to the sample accommodation portion in advance; and
a second step of determining an irradiation frequency for each laser irradiation location of the sample accommodation portion of the chip based on an irradiation frequency dependence of a signal strength for each irradiation location of the sample accommodation portion which is obtained by irradiating a laser to the sample accommodation portion,
wherein at least a matrix is in the sample accommodation portion.

11. The raster scan method of claim 9,
wherein the irradiation frequency is determined based on an irradiation frequency at which a signal of a strength equal to or more than a desired signal strength at the irradiation location is obtained.

12. The raster scan method of claim 9,
wherein the sample accommodation portion has a channel shape, and the raster scan is performed in a division unit obtained by dividing the sample accommodation portion in a channel width direction.

13. The raster scan method of claim 9,
wherein a sample is in the sample accommodation portion.

14. The raster scan method of claim 13,
wherein the sample is separated by electrophoresis.

15. The raster scan method of claim 9,
wherein the raster scan is performed at an interval of equal to or less than a laser diameter.

16. The raster scan system of claim 10, comprising:
a step of irradiating a laser to an irradiation location of the sample accommodation portion of the chip as many times as the irradiation frequency determined in the second step.

17. A computer-readable medium storing a program which raster-scans a sample accommodation portion of a chip through a laser, for allowing a computer to execute:
determining an irradiation frequency for each laser irradiation location of the sample accommodation portion of the chip based on an irradiation frequency dependence of a signal strength for each irradiation location of the sample accommodation portion which is obtained by irradiating a laser to the sample accommodation portion including at least matrix.

18. A computer-readable medium storing a program which raster-scans a sample accommodation portion of a chip through a laser, for allowing a computer to execute:
a first step of irradiating a laser to the sample accommodation portion including at least a matrix in advance; and
a second step of determining an irradiation frequency for each laser irradiation location of the sample accommodation portion of the chip based on an irradiation frequency dependence of a signal strength for each irradiation location of the sample accommodation portion which is obtained by irradiating a laser to the sample accommodation portion.
